(19) United States
(12) Patent Application Publication
(10) Pub. No.: US 2015/0320077 A1
(43) Pub. Date: Nov. 12, 2015

(54) Chewing Gum With Tobacco Fibres In The Gum Base

(71) Applicant: GUMLINK A/S, Vejle (DK)

(72) Inventor: Helle Wittorff, Vejle Ost. (DK)

(73) Assignee: OKONO A/S, Vejle (DK)

(21) Appl. No.: 14/647,361

(22) PCT Filed: Nov. 26, 2012
(86) PCT No.: PCT/DK2012/050434

§ 371 Date: May 26, 2015

(51) Int. Cl. A23G 4/06; A23G 4/08; A24B 13/00

(52) U.S. Cl. CPC A23G 4/068; A24B 13/00; A23G 4/08; A23V 2002/00

(57) ABSTRACT

Tobacco chewing gum compositions are provided including at least one water insoluble gum base portion and a water soluble bulk portion, wherein the at least one gum base portion and the bulk portion are combined, and wherein nicotine-containing tobacco fibres are included in the at least one gum base portion before combining the at least one gum base portion with the bulk portion.

### FIELD

The present invention relates to the field of tobacco chewing gum.

### BACKGROUND

A traditional way of including tobacco in a chewing gum formulation is by adding tobacco in the chewing gum formulation only after the gum base has been prepared. This may be done by adding tobacco while mixing an insoluble gum base matrix with a soluble bulk portion of the chewing gum formulation, or by adding tobacco to a bulk portion and then mixing the bulk portion with a gum base matrix.

In particular in relation to compressed chewing gum, tobacco is typically added as part of a soluble bulk portion and admixed with the already prepared gum base matrix. In the alternative, tobacco is added as part of a soluble bulk portion in an outer coating of a compressed chewing gum or as part of a powdered portion associated with the compressed chewing gum.

### SUMMARY OF THE INVENTION

Accordingly, there is provided a tobacco chewing gum composition where the chewing gum composition comprises at least one water insoluble gum base portion and a water soluble bulk portion, wherein the at least one gum base portion and the bulk portion is combined, and wherein nicotine-containing tobacco fibres are included in the at least one gum base portion before combining the at least one gum base portion with the bulk portion.

Furthermore, there is provided gum base granules comprising at least one water insoluble gum base portion, wherein tobacco fibres are included in the at least one gum base portion.

Finally, there is provided a method of producing a chewing gum composition, wherein at least one gum base portion and a bulk portion is combined, and wherein nicotine-containing tobacco fibres are included in the at least one gum base portion before combining the at least one gum base portion with the bulk portion.

### BRIEF DESCRIPTION OF THE DRAWINGS

FIG. 1 is a schematic representation of a chewing gum granulating system that may be employed to create chewing gum in accordance with the present invention; and

FIG. 2 is a representation of a die plate that may be employed in connection with the system of FIG. 1.

### DETAILED DESCRIPTION OF THE INVENTION

As used herein, the term “chewing gum composition” or “chewing gum formulation” intends to mean all chewable gum products.

The term “tobacco fibre” is intended to mean any part of the tobacco plant comprising cellulose, cellulose fibres and/or starch.

The term “nicotine” is intended to mean any nicotine compound associated with tobacco fibres.

The term “nicotine-containing” is intended to mean tobacco fibre with a content of nicotine.

The terms “gum base”, “gum base matrix” or “gum base portion” is intended to mean the mainly water insoluble and hydrophobic gum base ingredients that are mixed together before the bulk portion of the chewing gum composition is added.

The term “bulk portion” intends to mean the mainly water soluble and hydrophilic chewing gum ingredients that are mixed into the gum base matrix after the gum base matrix has been prepared.

The term “weight of the chewing gum formulation”, or similar wording meaning the same, is defined in the present context as weight of the chewing gum formulation or chewing gum composition, without including the weight of an outer coating, such as a hard coating, soft coating, and the like.

By the phrase “chewing gum” is meant any chewing gum such as extruded chewing gum, centre-filled chewing gum, toffee-imitating chewing gum, compressed chewing gum, slabs or sticks.

By the phrase “compressed chewing gum” is meant a chewing gum comprising granules or powder being exposed to a punching means in a tableting machine, pressing the granules or powder to a coherent mass of compressed material.

By the phrase “texture” is meant a qualitative measure of the visco-elastic properties of the chewing gum and of the overall mouth-feel experienced by the user during the chewing process. Thus the term “texture” encompasses measurable quantities such as hardness and elasticity as well as more subjective parameters related to the chew-feel experienced by a user.

By the phrase “retained” is meant that e.g. fibres of tobacco are contained within the gum base of the chewing gum formulation after it has been chewed.

The phrase “hydrophobic” is used to describe the ability of a substance to dissolve in or blend with apolar substances such as e.g. oils.

The phrase “hydrophilic” is used to describe the ability of a substance to dissolve in or blend with polar substances, such as e.g. water.

By the phrase “tobacco particles” is meant small parts made from tobacco leaves.

The term “buffered” intends to mean that the chewing gum system comprises an amount of buffer/buffering agent and thereby functions as a buffer system. A buffering agent in the present context is characterized by maintaining the pH level within certain relative constant pH values. In case of an alkaline buffer the pH level will be maintained at an alkaline level dependent on the pKa values in the buffer system. In case of an acidic buffer the pH level will be maintained at an acidic level dependent on the pKa values in the buffer system.

The term “in vivo chewing” intends to mean that the chewing gum system is chewed by a human subject in a experimental setup of trained test persons according to stastically principles and that either the saliva of the human subject is subject to measurements or the chewed chewing gum is subject to measurements of the amount of buffer or the pH level, the experimental setup being performed at a chewing frequency of 60 per minute.

The term “sustained” or “extended” is herein intended to mean prolonged over time.

The term “stability” is intended to mean under conditions of 40 degrees celcius and 70 percentage relative humidity during a period of 14 days, unless otherwise mentioned.

In one aspect of the present invention, there is thus provided a tobacco chewing gum composition where the chewing gum composition comprises at least one water insoluble gum base portion and a water soluble bulk portion, wherein the at least one gum base portion and the bulk portion is combined, and wherein nicotine-containing tobacco fibres are included in the at least one gum base portion before combining the at least one gum base portion with the bulk portion.

Generally, the invention relies on a new technical insight that it is critical in which way nicotine-containing tobacco fibres are included in a chewing gum formulation. In particular, the inclusion of nicotine-containing tobacco fibres together with a water-soluble bulk portion gives substantial different product characteristics than including nicotine-containing tobacco fibres in at least one gum base portion before combining the at least one gum base portion with the bulk portion.

The inventor of the present invention has seen that if nicotine-containing tobacco fibres are for instance mixed thoroughly into at least one gum base portion before combining the at least one gum base portion with the bulk portion, then there are beneficial effects associated with the properties of final product.

One of the benefits of the present invention is that the release of nicotine may be extended when compared to formulations where the tobacco fibres are not incorporated into the at least one gum base portion before combining with the bulk portion. Another benefit is that nicotine burning (throat irritation) is reduced. Another benefit is that the tobacco fibers may to more stable. Another benefit is that the texture may be improved. Another benefit of the present invention is that the taste may be improved.

In some embodiments of the invention, the tobacco fibres are included in the at least one gum base portion during an extrusion process in a continuous extrusion mixer.

The additional benefit of this embodiment may be a more efficient mixing of the tobacco fibres into the at least one gum base portion. This may also give the final product better properties. This may also give a substantial different product when compared to mixing by for instance Z-blade mixing.

The term “extrusion process” is intended to mean mixing in a continuous extrusion mixer at elevated temperatures for a specified period, whereby the tobacco fibres are thoroughly mixed into the at least one gum base portion.

The term “continuous extrusion mixer” is intended to mean a mixer where material may be allowed to be feeded continuously into one opening of the apparatus and allowed to be continuously mixed under elevated pressure and temperatures, typically by means of rotation by a snail means inside the apparatus, and conveyed at the longitudinal axis of the apparatus to one opening in the opposite side of the apparatus.

In some embodiment of the invention, the tobacco fibres are included in the at least one gum base portion during an extrusion process in a continuous extrusion mixer and allowed to mix for at least 20 seconds.

In some embodiment of the invention, the tobacco fibres are included in the at least one gum base portion during an extrusion process in a continuous extrusion mixer and allowed to mix for at least 30 seconds.

In some embodiment of the invention, the tobacco fibres are included in the at least one gum base portion during an extrusion process in a continuous extrusion mixer and allowed to mix for at least 40 seconds.

In some embodiment of the invention, the tobacco fibres are included in the at least one gum base portion during an extrusion process in a continuous extrusion mixer and allowed to mix for between 20 and 150 seconds.

In some embodiment of the invention, the tobacco fibres are included in the at least one gum base portion during an extrusion process in a continuous extrusion mixer and allowed to mix for between 20 and 60 seconds.

In some embodiments of the invention, the tobacco fibres are included in the at least one gum base portion during an extrusion process in a continuous extrusion mixer, whereby the at least one gum base portion and the tobacco fibres are introduced in a first section of the continuous extrusion mixer.

The term “a first section” is intended to mean a first opening at a point in the longitudinal axis of the extrusion mixer, preferably in the upper 10% of the extrusion mixer, such as the upper 20% of the extrusion mixer.

In some embodiments of the invention, the tobacco fibres are included in the at least one gum base portion during an extrusion process in a continuous extrusion mixer, whereby the at least one gum base portion is introduced in a first section of the continuous extrusion mixer and the tobacco fibres are introduced in a second section downstream of the first section of the continuous extrusion mixer.

The term “a second section” is intended to mean a second opening at a point in the longitudinal axis of the extrusion mixer, downstream of the first section of the continuous extrusion mixer.

In some embodiments of the invention, the tobacco fibres are included in the at least one gum base portion during an extrusion process in a continuous extrusion mixer, whereby the at least one gum base portion and the tobacco fibres is introduced in a first section of the continuous extrusion mixer and the tobacco fibres are also introduced in a second section downstream of the first section of the continuous extrusion mixer.

In some embodiments of the invention, the tobacco fibres are included in the at least one gum base portion in an amount from 5 to 40% by weight of the at least one gum base portion.

In some embodiments of the invention, the tobacco fibres are included in the at least one gum base portion in an amount from 5 to 30% by weight of the at least one gum base portion.

In some embodiments of the invention, the tobacco fibres are included in the at least one gum base portion in an amount from 5 to 20% by weight of the at least one gum base portion.

In some embodiments of the invention, the tobacco fibres are included in the at least one gum base portion in an amount from 6 to 15% by weight of the at least one gum base portion.

In some embodiments of the invention, the content of nicotine in the tobacco fibres is from 0.5 to 8% by weight of the particles of tobacco fibres.

In some embodiments of the invention, the content of nicotine in the tobacco fibres is from 0.8 to 6% by weight of the particles of tobacco fibres.

In some embodiments of the invention, the content of nicotine in the tobacco fibres is from 1.0 to 4% by weight of the particles of tobacco fibres.

In some embodiments of the invention, the content of nicotine in the tobacco fibres is from 1.2 to 3% by weight of the particles of tobacco fibres.

In some embodiments of the invention, the content of nicotine in the tobacco fibres is from 1.5 to 2.5% by weight of the particles of tobacco fibres.

In some embodiments of the invention, 90% of the tobacco fibres are below 300 microns.

In some embodiments of the invention, 90% of the tobacco fibres are below 200 microns.

In some embodiments of the invention, 90% of the tobacco fibres are below 100 microns.

In some embodiments of the invention, the tobacco fibres are present in a range of 1 to 10% by weight of the chewing gum composition.

In some embodiments of the invention, the tobacco fibres are present in a range of 1.5 to 8% by weight of the chewing gum composition.

In some embodiments of the invention, the tobacco fibres are present in a range of 2 to 5% by weight of the chewing gum composition.

In some embodiments of the invention, the at least one gum base portion comprises at least two of a gum resin, a synthetic resin, an elastomer and a plasticizer.

In some embodiments of the invention, the at least one gum base portion comprises a gum resin, a synthetic resin, an elastomer and a plasticizer.

In some embodiments of the invention, the at least one gum base portion comprises a gum resin, a synthetic resin and an elastomer.

In some embodiments of the invention, the at least one gum base portion comprises a gum resin and a synthetic resin.

In some embodiments of the invention, the at least one gum base portion comprises a gum resin and an elastomer.

In some embodiments of the invention, the at least one gum base portion comprises a synthetic resin and an elastomer.

In some embodiments of the invention, the at least one gum base portion comprises a synthetic resin and a plasticizer.

In some embodiments of the invention, the at least one gum base portion comprises an elastomer and a plasticizer.

In some embodiments of the invention, the continuous extrusion mixer is equipped with a die plate and a cutting means in order to produce a number of extruded granules by means of pressure in the continuous extrusion mixer.

In some embodiments of the invention, the extruded granules are conveyed into a water-filled chamber.

In some embodiments of the invention, the extruded granules are conveyed into an air-filled chamber.

In some embodiments of the invention, the at least one gum base portion is comprised in granules.

In some embodiments of the invention, the at least one gum base portion is in the form of granules.

The term “in the form of” is intended to mean essentially consisting of.

In some embodiments of the invention, the granules having an average size of 500-1300 microns.

In some embodiments of the invention, the at least one gum base portion is comprised in granules having an average size of 500-1300 microns.

In some embodiments of the invention, the at least one gum base portion is comprised in granules having an average size of 600-1200 microns.

In some embodiments of the invention, the at least one gum base portion is comprised in granules having an average size of 800-1200 microns.

In some embodiments of the invention, the at least one gum base portion and the bulk portion is combined and compressed into a compressed chewing gum tablet.

In some embodiments of the invention, the at least one gum base portion, in the form of granules, and the bulk portion, in the form of powder, is combined and compressed in a tableting machine into a compressed chewing gum tablet.

In some embodiments of the invention, the granules comprising at least on gum base portion and the bulk portion in the form of powder is combined and compressed in a tableting machine into a compressed chewing gum tablet.

In some embodiments of the invention, the at least one gum base portion, in the form of granules, and the bulk portion, in the form of powder, is combined and compressed in a tableting machine, and at least one further bulk portion, in the form of powder, is added in the tableting machine and compressed to form a multi-layered compressed chewing gum tablet.

In some embodiments of the invention, the granules comprising at least on gum base portion and the bulk portion, in the form of powder, is combined and compressed in a tableting machine, and at least one further bulk portion, in the form of powder, is added in the tableting machine and compressed to form a multi-layered compressed chewing gum tablet.

In some embodiments of the invention, the gum base content is in the range of 10 to 50% by weight of the chewing gum composition.

In some embodiments of the invention, the gum base content is in the range of 15 to 45% by weight of the chewing gum composition.

In some embodiments of the invention, the gum base content is in the range of 20 to 40% by weight of the chewing gum composition.

In some embodiments of the invention, the tobacco fibres are further included in the water soluble bulk portion.

In some embodiments of the invention, a further gum base portion without tobacco fibres is present.

Additionally, there is provided gum base granules comprising at least one water insoluble gum base portion, wherein tobacco fibres are included in the at least one gum base portion.

Furthermore, there is provided a method of producing a chewing gum, wherein the at least one gum base portion and the bulk portion is combined, and wherein nicotine-containing tobacco fibres are included in the at least one gum base portion before combining the at least one gum base portion with the bulk portion.

In an embodiment of the invention, the tobacco fibres are retained in the gum base after a 10 minute chewing process.

It may be a benefit that tobacco fibres are retained in the gum base, e.g. if the tobacco particles include harmful substances that may give rise to disorders in the human body.

Unless otherwise stated, when tobacco fibres or compounds are mentioned to be retained in the gum base or released from a chewing gum formulation after a chewing process, this chewing process refers to the procedure set forth in the Ph. Eur. 6^{th} ed. 2.9.25, at pH=7.4, a chewing rate of 60 chew per minute, and with the temperature of the medium at 37° C.

The measurement of the retained fibres or compounds may be established by measuring the amounts of retained tobacco fibres in the chewing gum after chewing or measuring the amounts of released tobacco fibres, whichever method is most appropriate.

The measurement of the retained fibres or compounds may be established by measuring the amounts remaining in the chewing gum after chewing or measuring the amounts of released components, whichever method is most appropriate.

Unless otherwise stated the retention of the tobacco particles in the gum base or the retention of the tobacco fibers from the tobacco in the gum base is measured as follows: The chewing gum is chewed referring to the procedure set forth in the Ph. Eur. 6^{th} ed. 2.9.25, at pH=7.4, a chewing rate of 60 chew per minute, and with the temperature of the medium at 37° C. for about 10 minutes. The buffer is filtered through weighed filter paper and the residue on the filter paper is dried in an oven at about 50° C. until dry. After weighing the dried filter paper with residue and subtracting a blind (dried filter paper without residue), the result is taken as tobacco fibres from tobacco released from the chewing gum. This is then compared to the amount of tobacco fibres in the chewing gum before chewing. By subtracting the measured released amount form the amount originally present and dividing by the amount originally present, the percentage retained may be calculated.

According to an advantageous embodiment of the present invention the tobacco fibres may be obtained by finely dividing tobacco leaves. To the surprise of the inventors a pleasant texture of the chewing gum may be obtained in this embodiment. In particular, it may be beneficial not to have too large fibres in the chewing gum formulation. Such large fibres may result in unpleasant chew characteristics. The preferred rate of the release of nicotine from the chewing gum may be found within the selected tobacco particle size range.

By the term “size” here is meant a measure of the maximum dimension of the tobacco fibres.

The presence of water in the tobacco fibres may affect both the ease of handling the tobacco particles in the production and also the initial softness of the chewing gum formulation. In addition the release rate of nicotine may be improved by selection of a preferred range of water content of the tobacco particles.

It has surprisingly been found by the present inventor that a relatively broad range of water content in the applied tobacco particles gives rise to chewing gum formulations with superior quality both with respect to nicotine release, taste and texture compared to nicotine-containing chewing gum of the prior art.

In some embodiments of the invention the water activity of the chewing gum composition is below 0.6, such as below 0.5, such as below 0.4.

According to embodiments of the present invention, the amount of tobacco particles in the chewing gum formulation has a pronounced influence on the taste, throat irritation, stability, texture and nicotine release.

The nicotine content of tobacco leaves may vary widely for different types of tobacco. According to advantageous embodiments of the present invention, the amount of nicotine in the tobacco particles may be higher than 0.2%. On the other hand, the amount of nicotine in the tobacco particles may, according to the aforementioned advantageous embodiments, be lower than 10% to better be able to mask the somewhat unpleasant taste of nicotine, when a certain amount of tobacco particles is applied.

In an embodiment of the invention the content of nitrosamines in the tobacco particles is less than 5 mg TSNA (Tobacco specific nitrosamines)/kg tobacco, such as less than 2, less than 1 or less than 0.5 mg TSNA/kg tobacco.

Natural tobacco may contain carcinogenic nitrosamines, which have been shown to be harmful to man, mainly due to their carcinogenic properties. Therefore, when tobacco particles with a comparatively low content of nitrosamines are used in the chewing gum formulation, further advantageous embodiments of the present invention are obtained.

In an embodiment of the invention the ratio by weight between gum base and tobacco particles is between 50:1 and 1:2, preferably between 25:1 and 1:1, such as between 10:1 and 2:1, and wherein the chewing gum formulation further comprises buffer.

The combination of tobacco particles and buffer in the chewing gum formulation has surprisingly shown synergistic effects with respect to both release of nicotine from the chewing gum formulation and the bio-availability of the released nicotine through the mucous membrane of the user.

In an embodiment of the invention the tobacco fibres are retained in the gum base after a chewing process.

To the surprise of the inventor, nicotine was seen to be released from the tobacco particles in the chewing gum formulation while the tobacco fibres surprisingly were retained in the gum base of the chewing gum formulation after chewing the formulation. In this way, the weight of the individual tobacco particle may diminish during the chewing process due to released substances, but a substantial part of the individual tobacco particle is retained in the gum base. In particular the tobacco fibre content of the tobacco particles may be retained in the chewing gum after a chewing process.

It has been found that the amount of gum base in the chewing gum influences the retention of tobacco particles or the retention of tobacco fibre content of the tobacco particles in the chewing gum formulation. A higher gum base content gives rise to a better retention which means that more tobacco fibres are retained in the chewing gum after chewing according to the procedures outlined above. When the gum base content of the chewing gum is lowered, the amount of retained tobacco fibres is less than for a higher gum base content.

In an embodiment of the invention more than 0.5 mg nicotine, such as more than 0.8 mg or more than 1.0 mg, is released from the chewing gum formulation within the first 5 minutes from initiation of a chewing process.

It has surprisingly been found by the present inventor that if a relatively fast release of nicotine from the chewing gum formulation is to be obtained, according to the present invention, it is advantageous to use tobacco particles as the source of nicotine.

By mixing tobacco particles with the hydrophobic gum base polymers prior to mixing with other chewing gum ingredients, a moderated release of nicotine from the chewing gum formulation may be obtained. In the present context it was seen as a surprise by the inventors that it was possible to mix the tobacco particles with the hydrophobic gum base polymers. In particular it was not foreseen that it was possible to mix the tobacco particles with the hydrophobic gum base polymers, when tobacco particles with a content of water were applied.

In embodiments of the present invention, the tobacco particles have a water content ranging from 2 to 40% by weight, preferably 5 to 30% by weight, such as 10 to 20% by weight.

In embodiments of the present invention, the amount of moisture contained in the tobacco particles is at least 2% by weight, such as at least 4%, at least 6%, or at least 8% by weight of the tobacco particles comprised in the chewing gum formulation.

In embodiments of the present invention, the amount of tobacco particles in the chewing gum formulation is at least 10 mg, such as at least 20 mg, at least 30 mg or at least 40 mg.

In embodiments of the present invention, the content of nitrosamines in the tobacco particles is less than 0.1 ng nitrosamines/mg nicotine, such as less than 0.05, less than 0.02 or less than 0.01 ng/mg nicotine.

In embodiments of the present invention, the content of nitrosamines in the tobacco particles is less than 5 ng nitrosamines/g tobacco, such as less than 2, less than 1, less than 0.5, less than 0.2 or less than 0.1 ng/g tobacco.

In embodiments of the present invention, the ratio by weight between gum base and tobacco particles is between 50:1 and 1:2, preferably between 25:1 and 1:1, such as between 10:1 and 2:1, and wherein the chewing gum formulation further comprises buffer.

In embodiments of the present invention, the amount of buffer is in the range of 0.1% to 10%, preferably 0.5% to 5% by weight of the chewing gum.

In embodiments of the present invention, the chewing gum formulation comprises buffer in an amount of less than 5%, such as less than 2%, less than 1%, or less than 0.5% by weight.

In embodiments of the present invention, the chewing gum formulation is substantially free of buffer.

In embodiments of the present invention, the buffer is selected from the group consisting of sodium carbonate, sodium hydrogen carbonate, potassium carbonate, potassium hydrogen carbonate, dipotassium phosphate, potassium citrate, or any combination thereof.

In embodiments of the present invention, the tobacco fibres are retained in the gum base after a chewing process.

In embodiments of the present invention, at least 20% by weight, at least 30% by weight, at least 40% by weight, 50% by weight, such as at least 60%, such as at least 65%, such as at least 70%, such as at least 75%, such as at least 80%, such as at least 85%, such as at least 90%, at least 95% or at least 99%, of the tobacco fibres are retained in the gum base about 10 minutes from initiation of a chewing process.

In embodiments of the present invention, more than 0.5 mg nicotine, such as more than 0.8 mg or more than 1.0 mg, is released from the chewing gum formulation within the first 5 minutes from initiation of a chewing process.

In embodiments of the present invention, more than 0.8 mg nicotine, such as more than 1.1 mg or more than 1.5 mg, is released from the chewing gum formulation within the first 10 minutes from initiation of a chewing process.

In embodiments of the present invention, more than 25% of the total nicotine content in the chewing gum formulation, such as more than 40% or more than 50%, is released from the chewing gum formulation within the first 5 minutes from initiation of a chewing process.

In embodiments of the present invention, more than 40% of the total nicotine content in the chewing gum formulation, such as more than 55% or more than 75%, is released from the chewing gum formulation within the first 10 minutes from initiation of a chewing process.

In embodiments of the present invention, the chewing process is carried out in vitro on a chewing machine in accordance with European Pharmacopeia 4th. ed. 2.9.25, with a phosphate buffer with a pH of 7.4.

In embodiments of the present invention, the released amounts are measured when the chewing gum formulation is chewed in vitro in accordance with European Pharmacopeia 4th. ed. 2.9.25 in a pH 7.4 phosphate buffer.

In embodiments of the present invention, the gum base comprises

elastomer in the range of 5-40% by weight of the gum base,

natural resin in the range of 8-45% by weight of the gum base, and

synthetic resin in the range of 5-95% by weight of the gum base.

In embodiments of the present invention, the chewing gum formulation comprises natural resins in an amount of 0.1 to 40%, preferably 1 to 30%, such as 3 to 25% or 5 to 20%, by weight of the chewing gum formulation.

In embodiments of the present invention, the chewing gum formulation comprises natural resins in an amount of at least 13% by weight of the chewing gum formulation.

In embodiments of the present invention, the chewing gum formulation comprises synthetic resins in an amount of 0.1 to 40%, preferably 1 to 30%, such as 3 to 25% or 5 to 20%, by weight of the chewing gum formulation.

In embodiments of the present invention, the chewing gum formulation comprises elastomer in an amount of at least 2% by weight of the chewing gum formulation, preferably at least 4% by weight of the chewing gum formulation.

In embodiments of the present invention, the chewing gum formulation comprises elastomer in an amount of less than 35% by weight of the chewing gum formulation, preferably less than about 25% by weight of the chewing gum formulation such as less than 20%, 15% or 10% by weight of the chewing gum formulation.

In embodiments of the present invention, the tobacco leaves have been exposed to a heat steaming process, thereby reducing the viable bacterial and fungal numbers of the tobacco leaves by at least 80%, preferably at least 90%, such as 99 or 99.9.

In embodiments of the present invention, the tobacco leaves have been exposed to a heat steaming process, thereby reducing the viable bacterial and fungal numbers in the tobacco leaves down below 10,000 CFU/g (colony-forming units per gram), such as below 1,000 or below 100 CFU/g.

In embodiments of the present invention, the chewing gum formulation comprises one or more flavoring agents selected from the group consisting of essential oils, essences, extracts, powders, acids, coconut, coffee, chocolate, vanilla, grape fruit, orange, lime, menthol, liquorice, caramel aroma, honey aroma, peanut, walnut, cashew, hazelnut, almonds, pineapple, strawberry, raspberry, apple, pear, peach, apricot, blackberry, cherry, pineapple, plum essence, clove oil, bay oil, anise, thyme, cedar leaf oil, nutmeg, cinnamon, peppermint, wintergreen, spearmint, eucalyptus, mint, or any combination thereof.

In embodiments of the invention, the chewing gum formulation comprises a tobacco flavoring, such as a tobacco casing.

In embodiments of the present invention, the chewing gum formulation comprises at least one of brightleaf, burley-leaf, oriental-leaf tobacco, Dark air cured Burley, Flue cured Virginia, and dark fired Kentucky.

Exemplary species of tobacco include N. rustica, N. tabacum, N. tomentosiformis, and N. sylvestris. Suitable tobaccos include fermented and unfermented tobaccos. In addition to fermentation, the tobacco can also be processed using other techniques. For example, tobacco can be processed by heat treatment (e.g., cooking, toasting), flavoring, enzyme treatment, expansion and/or curing. Both fermented and non-fermented tobaccos can be processed using these techniques. In other embodiments, the tobacco can be unprocessed tobacco. Specific examples of suitable processed tobaccos include, dark air-cured, dark fire cured, burley, flue cured, and cigar filler or wrapper, as well as the products from the whole leaf stemming operation.

The tobacco may, in some embodiments, be prepared from plants having less than 20 .mu.g of DVT per cm.sup.2 of green leaf tissue. For example, the tobacco particles can be selected from the tobaccos described in U.S. Patent Publication No. 2008/0209586, which is hereby incorporated by reference. Tobacco compositions containing tobacco from such low-DVT varieties exhibits improved flavor characteristics in sensory panel evaluations when compared to tobacco or tobacco compositions that do not have reduced levels of DVTs.

Green leaf tobacco can be cured using conventional means, e.g., flue-cured, barn-cured, fire-cured, air-cured or sun-cured. See, for example, Tso (1999, Chapter 1 in Tobacco, Production, Chemistry and Technology, Davis & Nielsen, eds., Blackwell Publishing, Oxford) for a description of different types of curing methods. Cured tobacco is usually aged in a wooden drum (i.e., a hogshead) or cardboard cartons in compressed conditions for several years (e.g., two to five years), at a moisture content ranging from 10% to about 25%. See, U.S. Pat. Nos. 4,516,590 and 5,372,149. Cured and aged tobacco then can be further processed. Further processing includes conditioning the tobacco under vacuum with or without the introduction of steam at various temperatures, pasteurization, and fermentation. Fermentation typically is characterized by high initial moisture content, heat generation, and a 10 to 20% loss of dry weight. See, e.g., U.S. Pat. Nos. 4,528,993, 4,660,577, 4,848,373, 5,372,149; U.S. Publication No. 2005/0178398; and Tso (1999, Chapter 1 in Tobacco, Production, Chemistry and Technology, Davis & Nielsen, eds., Blackwell Publishing, Oxford). Cure, aged, and fermented smokeless tobacco can be further processed (e.g., cut, shredded, expanded, or blended). See, for example, U.S. Pat. Nos. 4,528,993; 4,660,577; and 4,987,907.

In embodiments of the present invention, the chewing gum formulation comprises humectants, such as propylene glycol or glycerol.

In embodiments of the present invention, the chewing gum formulation comprises enhancers such as cocoa solids, licorice, tobacco extracts, and sugars.

In embodiments of the present invention, the chewing gum formulation is provided with a coating.

In embodiments of the present invention, the chewing gum formulation has a weight in the range of 0.1 to 10 grams, preferably in the range of 0.5 to 4 grams.

In embodiments of the present invention, the chewing gum comprises filler in an amount of 0.1 to 50% by weight of the chewing gum.

According to an advantageous embodiment of the invention, the chewing may comprise filler. The filler may advantageously be suitable for facilitating the water uptake of the fibres of the tobacco particles and it may also be suitable for facilitating the release of the ingredients of the tobacco particles when a user chews the chewing gum. In particular, it is noted that the filler may advantageously support the functionality of the fibres contained in the tobacco powder.

In embodiments of the invention, filler is added together with the tobacco fibres when tobacco fibres are mixed with the at least one gum base portion. This may be a benefit in order to avoid agglomeration.

In embodiments of the present invention, the chewing gum comprises filler in an amount of 0.1 to 50% by weight of the chewing gum, wherein the filler is hydrophobic and wherein at least 90% of the filler is contained in the chewing gum throughout the chewing of a user during a chewing period of at least 10 minutes.

According to an advantageous embodiment of the invention the chewing gum comprises filler in an amount of 0.1 to 50% by weight of the chewing gum, wherein the filler is hydrophobic and wherein at least 90% of the filler is contained in the chewing gum throughout the chewing of a user during a chewing period of at least 10 minutes.

The chewing of the chewing gum throughout the period of at least 10 minutes may be set forth by the procedure set forth in the Ph. Eur. 6^{th} ed. 2.9.25, at pH=7.4, a chewing rate of 60 chew per minute, and with the temperature of the medium at 37° C., whereas the measurement of the retained filler may be established by measuring on the remaining chewing gum or measuring of the released components, whichever method is most appropriate.

In embodiments of the present invention, the chewing gum comprises filler in an amount of 0.1 to 50% by weight of the chewing gum and wherein the filler comprises magnesium and calcium carbonate, sodium sulphate, ground limestone, silicate compounds such as magnesium and aluminum silicate, kaolin and clay, aluminum oxide, silicium oxide, talc, titanium oxide, mono-, di- and tri-calcium phosphates, cellulose polymers, such as wood, and combinations thereof

In embodiments of the present invention, the chewing gum is a compressed chewing gum tablet.

In embodiments of the present invention, the compressed chewing gum tablet is a multi-layer tablet.

In embodiments of the present invention, the compressed chewing gum tablet is composed of one layer without gum base and one layer with gum base.

In embodiments of the present invention, the compressed chewing gum tablet is composed of one layer without gum base and one layer with gum base on each side of the layer without gum base.

In embodiments of the present invention, the compressed chewing gum tablet is composed of one layer with gum base and one layer without gum base on each side of the layer with gum base.

In embodiments of the present invention, the chewing gum has the form of a slab or stick.

In an embodiment of the invention, the tobacco particles comprises tobacco fibres and at least 20% of the tobacco fibres are retained in the gum base after a 10 minute chewing process.

In embodiments of the present invention, at least 30%, preferably at least 40% and even more preferred at least 50% of the tobacco fibres are retained in the chewing gum after the chewing gum has been chewed in vitro in accordance with European Pharmacopeia 4th. ed. 2.9.25 in a pH 7.4 phosphate buffer for 10 minutes.

In embodiments of the present invention, at least 60% of the tobacco fibres are retained in the chewing gum after the chewing gum has been chewed in vitro in accordance with European Pharmacopeia 4th. ed. 2.9.25 in a pH 7.4 phosphate buffer for 10 minutes.

In embodiments of the present invention, at least 70% of the tobacco fibres are retained in the chewing gum after the chewing gum has been chewed in vitro in accordance with European Pharmacopeia 4th. ed. 2.9.25 in a pH 7.4 phosphate buffer for 10 minutes.

In embodiments of the present invention, at least 80% of the tobacco fibres are retained in the chewing gum after the chewing gum has been chewed in vitro in accordance with European Pharmacopeia 4th. ed. 2.9.25 in a pH 7.4 phosphate buffer for about 10 minutes.

In embodiments of the present invention, at least 85% of the tobacco fibres are retained in the chewing gum after the chewing gum has been chewed in vitro in accordance with European Pharmacopeia 4th. ed. 2.9.25 in a pH 7.4 phosphate buffer for about 10 minutes.

In an embodiment of the invention the relative release of nicotine from the tobacco powder in the chewing gum formulation is greater than the relative release of tobacco fibres from the chewing gum formulation when the chewing gum formulation is chewed for 10 minutes.

In some embodiments of the invention, a buffer is added, the buffer being selected from the group consisting of a tris buffers, amino acid buffers, carbonate, including monocarbonate, bicarbonate or sesquicarbonate, glycerinate, phosphate, glycerophosphate, acetate, glyconate or citrate of an alkali metal, such as potassium and sodium, e.g. trisodium and tripotassium citrate, or ammonium, and mixtures thereof.

When buffer is used, a preferred buffer is sodium bicarbonate. In some embodiments buffer is not part of the chewing gum formulation. In some other embodiments, buffer is part of the chewing gum formulation.

In some embodiments of the invention, the amount of buffer is 0.5 to 10% by weight of the chewing gum formulation.

In some embodiments of the invention the buffer is selected from the group consisting of a carbonate, including monocarbonate, bicarbonate or sesquicarbonate, glycerinate, phosphate, glycerophosphate, acetate, glyconate or citrate of an alkali metal, such as potassium and sodium, e.g. trisodium and tripotassium citrate, or ammonium, tris buffer, amino acids, and mixtures thereof.

However, in a presently preferred embodiment an alkaline buffer is preferred, such as sodium carbonate.

According to the invention the presence of buffer allows in synergy with tobacco particles in the chewing gum formulation to adjust the release of nicotine from the tobacco particles and the bioavailability of the released nicotine in the oral cavity.

Elastomers provide the rubbery, cohesive nature to the gum, which varies depending on this ingredient's chemical structure and how it may be compounded with other ingredients. Elastomers suitable for use in the gum base and gum of the present invention may include natural or synthetic types.

Elastomer plasticizers vary the firmness of the gum base. Their specificity on elastomer inter-molecular chain breaking (plasticizing) along with their varying softening points cause varying degrees of finished gum firmness and compatibility when used in base. This may be important when one wants to provide more elastomeric chain exposure to the alkane chains of the waxes.

The elastomers (rubbers) employed in the gum base may vary depending upon various factors such as the type of gum base desired, the texture of gum formulation desired and the other components used in the formulation to make the final chewing gum product. The elastomer may be any water-insoluble polymer known in the art, and includes those gum polymers utilized for chewing gums and bubble gums. Illustrative examples of suitable polymers in gum bases include both natural and synthetic elastomers. For example, those polymers which are suitable in gum base formulations include, without limitation, natural substances (of vegetable origin) such as chicle gum, natural rubber, crown gum, nispero, rosidinha, jelutong, perillo, niger gutta, tunu, balata, guttapercha, lechi capsi, sorva, gutta kay, and the like, and mixtures thereof. Examples of synthetic elastomers include, without limitation, styrene-butadiene copolymers (SBR), polyisobutylene, isobutylene-isoprene copolymers, polyethylene, polyvinyl acetate and the like, and mixtures thereof.

Natural resins may be used according to the invention and may be natural rosin esters, often referred to as ester gums including as examples glycerol esters of partially hydrogenated rosins, glycerol esters of polymerised rosins, glycerol esters of partially dimerized rosins, glycerol esters of tally oil rosins, pentaerythritol esters of partially hydrogenated rosins, methyl esters of rosins, partially hydrogenated methyl esters of rosins, pentaerythritol esters of rosins, synthetic resins such as terpene resins derived from alpha-pinene, beta-pinene, and/or d-limonene, and natural terpene resins.

In an embodiment of the invention, the resin comprises terpene resins, e.g. derived from alpha-pinene, beta-pinene, and/or d-limonene, natural terpene resins, glycerol esters of gum rosins, tall oil rosins, wood rosins or other derivatives thereof such as glycerol esters of partially hydrogenated rosins, glycerol esters of polymerized rosins, glycerol esters of partially dimerised rosins, pentaerythritol esters of partially hydrogenated rosins, methyl esters of rosins, partially hydrogenated methyl esters of rosins or pentaerythritol esters of rosins and combinations thereof.

In an embodiment of the invention, said chewing gum ingredients are selected from the group consisting of bulk sweeteners, flavors, dry-binders, tabletting aids, anti-caking agents, emulsifiers, antioxidants, enhancers, absorption enhancers, buffers, high intensity sweeteners, softeners, colors, or any combination thereof.

The tobacco particles may in some embodiments of the invention be added to the chewing gum as a part of the bulk portion together with the other chewing gum ingredients.

In an embodiment of the invention, the chewing gum formulation comprises sweeteners, such as bulk sweeteners, sugar sweeteners, sugar substitute sweeteners, artificial sweeteners, high-intensity sweeteners, or any combination thereof.

Suitable bulk sweeteners include both sugar and non-sugar sweetening components. Bulk sweeteners typically constitute from about 5 to about 95% by weight of the chewing gum, more typically about 20 to about 80% by weight such as 30 to 70% or 30 to 60% by weight of the gum.

Useful sugar sweeteners are saccharide-containing components commonly known in the chewing gum art including, but not limited to, sucrose, dextrose, maltose, dextrins, trehalose, D-tagatose, dried invert sugar, fructose, levulose, galactose, corn syrup solids, and the like, alone or in combination.

Sorbitol can be used as a non-sugar sweetener. Other useful non-sugar sweeteners include, but are not limited to, other sugar alcohols such as mannitol, xylitol, hydrogenated starch hydrolysates, maltitol, isomalt, erythritol, lactitol and the like, alone or in combination.

High intensity artificial sweetening agents can also be used alone or in combination with the above sweeteners. Preferred high intensity sweeteners include, but are not limited to sucralose, aspartame, salts of acesulfame, alitame, saccharin and its salts, cyclamic acid and its salts, glycyrrhizin, dihydrochalcones, thaumatin, monellin, sterioside and the like, alone or in combination. In order to provide longer lasting sweetness and flavor perception, it may be desirable to encapsulate or otherwise control the release of at least a portion of the artificial sweeteners. Techniques such as wet granulation, wax granulation, spray drying, spray chilling, fluid bed coating, conservation, encapsulation in yeast cells and fiber extrusion may be used to achieve desired release characteristics. Encapsulation of sweetening agents can also be provided using another chewing gum component such as a resinous compound.

Usage level of the artificial sweetener will vary considerably and will depend on factors such as potency of the sweetener, rate of release, desired sweetness of the product, level and type of flavor used and cost considerations. Thus, the active level of artificial sweetener may vary from about 0.001 to about 8% by weight (preferably from about 0.02 to about 8% by weight). When carriers used for encapsulation are included, the usage level of the encapsulated sweetener will be proportionately higher. Combinations of sugar and/or non-sugar sweeteners may be used in the chewing gum formulation.

A chewing gum base formulation may, if desired, include one or more fillers/texturisers including as examples, magnesium and calcium carbonate, sodium sulphate, ground limestone, silicate compounds such as magnesium and aluminum silicate, kaolin and clay, aluminum oxide, silicium oxide, talc, titanium oxide, mono-, di- and tri-calcium phosphates, cellulose polymers, such as wood, and combinations thereof.

A number of chewing gum components well known within the art may be applied within the scope of the present invention. Such components comprise but are not limited to waxes, fats, softeners, fillers, flavors, anti-oxidants, emulsifiers, colouring agents, binding agents and acidulants

In an embodiment of the invention, the chewing gum formulation is provided with an outer coating.

In an embodiment of the invention, said outer coating is selected from the group consisting of hard coating, soft coating and edible film-coating or any combination thereof

According to an embodiment of the present invention tobacco fibres may be added during the preparation of the gum base matrix at elevated temperatures.

According to an embodiment of the present invention the temperature when adding tobacco fibres during gum base matrix preparation exceeds about 60° C.

In some embodiments of the present invention, the temperature when adding tobacco fibres during gum base matrix preparation exceeds about 80° C.

In further embodiments the temperature when adding tobacco fibres during gum base matrix preparation exceeds about 100° C.

According to provisions of the present invention the temperature when adding tobacco fibres during gum base matrix preparation is about 120° C.

In an embodiment of the present invention, the addition of tobacco fibres during the preparation of the gum base matrix is facilitated by the above mentioned elevated temperatures.

It should be noted that various concentrations of gum base matrix in the final chewing gum core may be applied within the scope of the invention.

In an embodiment of the invention, said chewing gum formulation comprises one or more encapsulation delivery systems.

In one embodiment of the invention, the flavor may be used as taste masking in chewing gum comprising active ingredients, which by themselves have undesired taste or which alter the taste of the formulation.

Moreover the invention relates to gum base granules comprising a water insoluble gum base matrix wherein the gum base granules comprise a first amount of buffer.

Through the addition of buffer into the gum base granules, a high pH-release chewing gum may be obtained when the chewing gum is based on the gum base granules.

According to the invention the gum base granules may include embodiments mentioned in the context of the chewing gum formulation pertaining to the product claims of the present invention where applicable.

The size of granules according to the present invention are controlled by several factors such as opening sizes, the gum composition, gum temperature at and pressure drop, if a die plate is used. Due to an interaction between the pressurized gum composition, temperature and friction in the openings of the die device, the average diameter of the produced granules are normally larger than the diameters of the openings in the die device. The relation between the diameters of the openings in the die device and the average diameters of granules produced from a specific gum composition may be determined by the skilled person on basis of routine experiments.

According to the invention it is also possible to produce granules with different average diameters by making granules with one diameter, and subsequently mix the granules with different average diameters in desired proportions.

Although the openings of the die device may have cross-sections of any desired shape, e.g. circular, oval, square etc., it is preferred that the die device comprises openings with substantially circular cross-section and diameters in the range of 0.1 to 1.3 mm. A first set of openings can e.g. have a first diameter in the range of 0.07 to 0.7 mm, preferably in the range of 0.15 to 0.6 mm, and suitably in the range of 0.2 to 0.5 mm. A second set of openings can have a second diameter larger than said first diameter. The second diameter is conveniently in the range of 0.4 to 1.3 mm, preferably in the range of 0.7 to 1.2 mm.

Preferably the chewing gum granulating system further comprises a drying device. Powder sweetener or talk may be added to the granules in a final drying step. The drying device can be a conventional centrifugal dryer or another suitable dryer e.g. a fluid bed dryer. The drying device can, for example, include a mixer. The powder sweetener is preferably sorbitol, which is mixed to the dried or partially dried granules. Minor amounts of residual moisture on the surface of the granules, e.g. 2% Wt. based on the total weight of the granules, may contribute to the adherence of the sorbitol powder to the surface of the granules. It is possible to use a conventional anti-agglomerating agent as e.g. talcum, but sorbitol powder can function as an anti-agglomerating agent, and at the same time serves as sweetener. Although sorbitol is found to be most suitable, other bulk sweeteners based on polyols may also be suitable, e.g. mannitol, xylitol, hexa-resorcinol, maltitol, isomaltol, erythriol, and lactitol.

In a preferred embodiment the chewing gum granulating system according to the invention further comprises one or more sieves adapted for removing granules with an average diameter such as above 1.3 mm. The removal of larger granules improves a subsequent tabletting process.

According to the invention it is preferred that at least the extruder and/or the die device comprises means for controlling the temperature of the gum composition. The means for controlling temperature can be cooling or heating devices, and may serve to facilitate the flow of gum composition through the extruder and the die device. In an embodiment the extruder comprises delivering means for delivering sweetener and/or flavour to the gum composition in the extruder.

During extrusion of the gum composition the differential pressure between the gum composition in the extruder and the gum composition in the liquid filled chamber, i.e. over the die device is suitably above 10 bar, preferably above 18 bar, such as in the range of 25 to 90 bar. The temperature of the gum composition in the extruder is preferably in the range of 40 to 125° C., suitably in the range 50 to 115° C. The temperature of the die device is preferably in the range of 60 to 250° C., suitably in the range 80 to 180° C. The temperature of the liquid in the liquid filled chamber is conveniently in the range of 8 to 40° C. The optimum for the pressures and temperatures in the method according to the invention may, however, may be determined by the skilled person as a matter of routine. The optimum values for specific gum compositions, varies of course, depending on the composition.

The quick cooling in the air filled or water-filled chamber may act to preserve possible fragile ingredients in the gum composition so that their qualities are better kept intact and conveyed into the granules included in the final gum product. This improved quality of the gum composition in the granules improves the general composition of the chewing gum product.

Granule fractions of different average weights may be produced with two different setups, each producing a batch of granules of a particular average weight, followed by a blending of the fractions. It is also possible to design a die means with die openings of at least two different sizes to simultaneously obtain granules with different average diameter. Thus it is possible to obtain granules having different weights. More than two different average weights may be obtained, depending on the design of the die means in use. It is for instance possible to obtain granules with three, four or more different average weights although two different weights are preferred.

The granules may be cut in a very large liquid-filled chamber, in which the granules are also cooled, but preferably the cooling is combined with transfer of the granules away from the chamber. This can be done e.g. by cooling the cut granules in water during transfer from the liquid filled chamber to a de-watering device. The transfer time from cutting to de-watering can be less than 6 s. The advantage of this is that water-soluble ingredients in the gum composition are not unnecessarily washed out of the granules. Optionally, the total time of contact between granules and cooling water can be further limited to less than 4 s.

It is preferred that the gum composition fed to the extruder is a gum base, and that it at least includes one or more flavouring agents when extruded through the die means.

The flavours within the granules cause a prolonged release of taste during mastication.

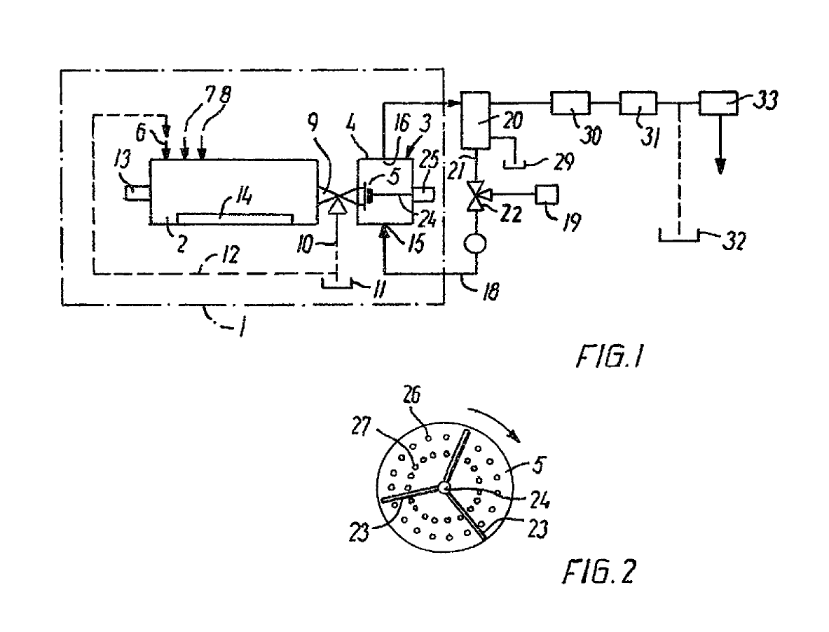

FIG. 1 and FIG. 2 is only of illustrative character and my not been seen to limit the present invention to only this embodiment. The embodiments(s) are intended to show at least one way of carrying out the present invention.

In FIG. 1 a chewing gum granulating system generally denoted 1 comprises at least an extruder 2 and a granulating apparatus 3 having a chamber 4 with a die plate 5.

The extruder 2 is equipped with a first opening with a hopper 6 for feeding gum base to the extruder 2. In the illustrated embodiment the extruder 2 is further equipped with second opening 7 and third opening 8 connected to further inlets for feeding additives to the gum base in the extruder 2. The additive feeding device 7 can e.g. be used for adding tobacco fibres, and the additive feeding device 8 can e.g. be used for adding tobacco fibres. Tobacco powder is preferably added in the first opening. Additional ingredients may be added in the openings 6-8.

The extruder 2 delivers pressurized gum composition to the inlet side of die means in the form of a die plate 5, via a flow connection between an outlet on the extruder and an inlet of the granulating apparatus. The flow connection is provided with a valve 9, which in one position provides unrestricted passage from the extruder to the die plate, and in another position connect the extruder outlet with a drain pipe 10, which either leads to a receptacle 11 for discharged gum composition or to a recycling pipe 12 by which the gum composition can be recycled to hopper 6.

The extruder 2 can be a single or double screw extruder provided with a drive motor 13, preferably an electric motor with settable speed, or a hydraulic motor. In another embodiment of the extruder feeding devices 7, 8 have been omitted, and hopper 6 can then be supplied with pre-mixed gum composition of any desired type. The extruder has one or more heating devices 14 which can be included in the barrel of the extruder or can be associated with the screw. The heating device or devices can e.g. be of electrical heater type or heat exchanger type where the latter can be supplied with heating fluid such as hot water or hot oil. The die plate can also be provided with a heating device, which typically is of the type of internal channels in the plate, and a supply of hot heating liquid feeding the internal channels with the required amount of heat.

The water-filled or liquid-filled granulating chamber 4 has an inlet 15 for cooling liquid and an outlet 16 for a slurry of suspended granules and cooling liquid. The cooling liquid is supplied by a pump 17 via an inlet pipe 18, and the pump can be fed with fresh cooling liquid from a source 19 or it can be supplied with re-circulated cooling liquid from a de-watering unit 20 via a pipe 21. A control valve 22 regulates the degree of re-circulation. The system can also have an intercooler (not shown) for cooling re-circulated cooling liquid.

Cutting means, such as rotating knives 23, act on the outlet side of the die plate. The gum composition extruded through openings in the die plate is cut into granules by the cutting means. The cutting means can be reciprocating knives, but is preferably embodied as rotating knives 23 mounted at the end of a drive axle 24 which is driven by a motor 25, such as an electric motor or a hydraulic drive motor. The motor 25 preferably has settable speed.

The die plate is exchangeable so that several different die plates with different configuration of the openings can be used in the same granulating apparatus. The actual die plate configuration is chosen according to the desired weight of granules. It is possible to use a die plate with a plurality of uniformly sized openings in order to produce a batch of gum granules with practically uniform weight (the first average weight). Another batch of granules with a different, second average weight can be produced by making another run using a different die plate configuration. It is, however, preferred to use a die plate provided with differently sized openings so that granules of different weights can be simultaneously produced in the same run.

FIG. 2 depicts an example of such a die plate 5 where an outer row of openings 26 are larger than an inner row of openings 27. The openings can be provided in any desired configuration of sizes and patterns, the pattern and sizes being selected so that the desired weights of granules are obtained.

An outlet pipe 28 connects outlet 16 with a dryer device in the form of de-watering unit 20, in which the granules are separated from the cooling liquid. The dryer device can be of any commercially available type. Spent cooling liquid can be drained off to drain 29 or be re-circulated via pipe 21. The dryer can also be associated with a mixer 30 wherein the granules are mixed with e.g. anti-agglomerating agent, sweetener, flavour, tabletting aids etc. to form a mixture. The system can optionally include a classifying unit 31 with one or more sieves. The granules can be stored temporarily in a storage 32. Granules are either directly after de-watering and possible dusting or coating or after a possible intermediate storage and/or mixing with granules of different average weights or types fed to a tablet pressing machine 33 in which the granules are included in compressed gum tablets.

According to the present invention, the embodiments mentioned in the specification of this patent application may be combined according to the present invention.

The following non-limiting examples illustrate different variations of the present invention. The examples are meant for indicating the inventive concept; hence the mentioned examples should not be understood as exhaustive for the present invention.

### EXAMPLES

### Example 1

### Preparation of Gum Base without Tobacco Particles

The composition of a gum base is presented in Table 1.

TABLE 1
Gum base composition. Amounts are given in wt-% of the gum base.

| | GB std. |
|---|---|
| Elastomer | 16.0 |
| Resins | 44.5 |
| Filler | 15.0 |
| Plasticizers | 24.4 |
| Antioxidant | 0.1 |

GB = Gum Base.

The preparation of gum base in this example is carried out by first adding a high-molecular weight elastomer, synthetic resin and filler to a heated (about 120° C.) and running z-blade mixer. After about twenty minutes of mixing, natural resin is added to the running mixer and mixing is continued for about five minutes followed by addition of further natural resin. After about five minutes of continued mixing, some plasticizer and further elastomer are added to the running mixer, and mixing is continued for about five minutes before addition of further plasticizer and antioxidant to the running mixer. Mixing is continued for about half an hour to one hour, and the final gum base mass is emptied from the mixer into coated or lined pans, extruded or cast into any desirable shape. Those skilled in the art will recognize that many variations of the above-described procedure may be followed.

### Example 2

### Preparation of Chewing Gum

In the present example, the gum base standard from example 1 GB std. was made into chewing gum CG std. with the composition as described in Table 2.

TABLE 2
Amounts are given in % by weight of the chewing gum formulation.

| | CG std. |
|---|---|
| GB std. | 42 |
| Tobacco particles | 5 |
| Bulk Sweetener | 50.3 |
| Sorbitol | |
| Tobacco flavour | 2 |
| Intense sweeteners | 0.7 |

CG = Chewing Gum

A conventional mechanical mixing procedure is used. The gum base is added to a mixing kettle provided with mixing means like e.g. horizontally placed Z-shaped arms. The kettle had been preheated to a temperature of up to approximately 50° C., and the other ingredients are added according to a specified time schedule. Obviously, the amount of ingredients used may be varied within the scope of the present invention.

The chewing gum formulation may optionally be coated by means of hard coating. The coating may e.g. be applied according to conventional coating methods. The pieces evaluated are without coating.

### Example 3

### Preparation of Chewing Gum with Tobacco Particles, Size/Amount

Chewing gums comprising varying sizes and amounts of tobacco particles were made according to various embodiments of the present invention.

The chewing gum of example 2 was used with tobacco particles with tobacco amount and size as indicated in Table 3 replacing the corresponding amount of bulk sweetener. The resulting chewing gums are in Table 3 named for later reference.

TABLE 3
Avg. size is the average maximum dimension of the tobacco particles and
the amount of tobacco is given in % by weight of the chewing gum

| | Avg. size (μm) | | | | |
|---|---|---|---|---|---|
| Tobacco (wt-%) | 40 | 250 | 500 | 750 | 2500 |
| 1 | CG01 | CG06 | CG11 | CG16 | CG21 |
| 5 | CG02 | CG07 | CG12 | CG17 | CG22 |
| 10 | CG03 | CG08 | CG13 | CG18 | CG23 |
| 20 | CG04 | CG09 | CG14 | CG19 | CG24 |
| 30 | CG05 | CG10 | CG15 | CG20 | CG25 |

The chewing gum with lower tobacco content (1-5 wt-%) had a mild taste of tobacco while with higher tobacco content (10-30 wt-%) had a distinct and pleasant tobacco taste.

### Example 4

### Preparation of Chewing Gum with Tobacco Particles, Nicotine Content

Chewing gums comprising tobacco particles with varying nicotine content were made according to various embodiments of the present invention. The varying nicotine content may be obtained by using either low- and/or high-nicotine containing types of tobacco in any combination. Hereby a desired nicotine content in the tobacco particles to be used may be obtained as seen in Table 4 below. The chewing gum of example 2 was used with different types of tobacco particles replacing the corresponding amount of bulk sweetener, which contained amounts of nicotine as indicated in Table 4. The resulting chewing gums are in Table 4 named for later reference.

TABLE 4
The amount of tobacco is given in % by weight of the chewing gum
and the amount of nicotine is given in % by weight of the tobacco.

| | Tobacco (wt-%) | | | | |
|---|---|---|---|---|---|
| Nicotine (wt-%) | 1 | 5 | 10 | 20 | 30 |
| 0.3 | CG26 | CG31 | CG36 | CG41 | CG46 |
| 0.7 | CG27 | CG32 | CG37 | CG42 | CG47 |
| 1.7 | CG28 | CG33 | CG38 | CG43 | CG48 |
| 3.4 | CG29 | CG34 | CG39 | CG44 | CG49 |
| 8.4 | CG30 | CG35 | CG40 | CG45 | CG50 |

Surprisingly, the chewing gums with highest nicotine content still had a pleasant taste and texture.

### Example 5

### Preparation of Chewing Gum with Tobacco Particles, Moisture Content

Chewing gums comprising tobacco particles with varying moisture content were made according to various embodiments of the present invention. The varying moisture content may be obtained by drying or adding extra water to any type of tobacco before adding it to the chewing gum. Hereby a desired moisture content in the tobacco particles to be used may be obtained as seen in Table 5 below.

The chewing gum of example 2 was used with tobacco particles, which had a moisture content as indicated in Table 5, replacing the corresponding amount of bulk sweetener. The resulting chewing gums are in Table 5 named for later reference.

TABLE 5
The amount of tobacco is given in % by weight of the chewing gum
and the moisture content is given in % by weight of the tobacco.

| | Tobacco (wt-%) | | | | |
|---|---|---|---|---|---|
| Moisture (wt-%) | 1 | 5 | 10 | 20 | 30 |
| 2 | CG51 | CG56 | CG61 | CG66 | CG71 |
| 5 | CG52 | CG57 | CG62 | CG67 | CG72 |
| 11 | CG53 | CG58 | CG63 | CG68 | CG73 |
| 18 | CG54 | CG59 | CG64 | CG69 | CG74 |
| 26 | CG55 | CG60 | CG65 | CG70 | CG75 |

Surprisingly, the moisture content of the tobacco particles may be varied without compromising taste and texture of the chewing gum.

### Example 6

### Preparation of Chewing Gum with Tobacco Particles, Buffer

Chewing gums comprising tobacco particles with varying sizes were combined with various amounts of buffer according to various embodiments of the present invention.

The chewing gum of example 2 was used with buffer in amounts as indicated in Table 6 and tobacco particles in an amount of 5% of the chewing gum replacing the corresponding amount of bulk sweetener. The buffer used was a 50/50 by weight of NaHCO₃ and Na₂CO₃. The resulting chewing gums are in Table 5 named for later reference.

TABLE 6
The nicotine content is given in % by weight of the tobacco particles and
the buffer content is given in % by weight of the chewing gum

| | Nicotine (wt-%) | | |
|---|---|---|---|
| Buffer (wt-%) | 0.7 | 2.4 | 4.3 |
| 0 | CG76 | CG81 | CG86 |
| 0.5 | CG77 | CG82 | CG87 |
| 3 | CG78 | CG83 | CG88 |
| 6 | CG79 | CG84 | CG89 |
| 8 | CG80 | CG85 | CG90 |

### Example 7

### Preparation of Chewing Gum with Tobacco Particles, GB-Ingredients

Chewing gums with tobacco particles in combination with varying gum base ingredients were made according to various embodiments of the present invention. The resulting gum bases were made into chewing gums in accordance with the description in example 2. The resulting chewing gums are in Table 7 named for later reference.

TABLE 7
The content of the individual ingredients
are given in % by weight of the gum base.

| | CG91 | CG92 | CG93 | CG94 | CG95 | CG96 | CG97 |
|---|---|---|---|---|---|---|---|
| Elastomer | 16.0 | 17.5 | 10.0 | 16.0 | 13.0 | 19.0 | 15.0 |
| Resins | 44.5 | 48.0 | 49.7 | 40 | 37.5 | 26.5 | 32.5 |
| Filler | 1.0 | 2.5 | 2.6 | 6.5 | 11.0 | 16.0 | 4.0 |
| Plasticizers | 24.4 | 18 | 23.6 | 23.5 | 24.4 | 24.4 | 34.4 |
| Antioxidant | 0.1 | 0.05 | 0.1 | 0.0 | 0.1 | 0.1 | 0.1 |
| Tobacco | 14 | 14 | 14 | 14 | 14 | 14 | 14 |

### Example 8

### In Vitro Release of Nicotine

The release rate of nicotine from CG14 in Example 3 with tobacco particles with app. 11% moisture content and 2-3% nicotine, was measured according to the procedure set forth in the Ph. Eur. 6^{th} ed. 2.9.25, at pH=7.4, a chewing rate of 60 chew per minute, and with the temperature of the medium at 37° C. With the same setting, the release rate from three prior art pieces, PA1, PA3, PA4, of nicotine gum was measured for comparison. The release rate can be seen in Table 8.

TABLE 8
the time given is from initiation of a chewing process as described
and the values given are % by weight of the total content of
nicotine in the products

| | CG14 | | | | PA3 |
|---|---|---|---|---|---|
| Time | (Wt-%) | PA4 (Wt-%) | CG98 (Wt-%) | PA1 (Wt-%) | (Wt-%) |
| 5 min | 61 | 51 | 83 | 45 | 15 |
| 10 min | 85 | 72 | 91 | 66 | 36 |
| 20 min | 89 | 92 | 95 | 83 | 56 |
| 30 min | 90 | 95 | 97 | 90 | 70 |

The results clearly show a significantly faster release of nicotine from the tobacco chewing gum formulation according to an embodiment of the present invention as compared to conventional nicotine gum.

A number of further measurements were carried out with other chewing gums with varying contents of tobacco particles, elastomers, resins and buffer were tested and showed in general an improved faster release of nicotine as compared to conventional chewing gum.

It is noted that the CG14 and PA4 are directly comparable and both have the same gum base composition and gum base content.

The gum base content and gum base composition is also the same for CG98 and PA1 but differs from CG14 and PA4.

The chewing gum composition of PA3 is unknown but refers to a Nicorette nicotine chewing gum where nicotine is contained in the form of a nicotine polacrilex resin (NPR), as is also the case for PA1 and PA4.

### Example 9

### In Vitro Release, Retention of Fibres of Tobacco Particles

The retention of the fibres of tobacco particles in the gum base upon chewing chewing gum was investigated by carrying out the procedure set forth in the Ph. Eur. 6^{th} ed. 2.9.25, at pH=7.4, a chewing rate of 60 chew per minute, and with the temperature of the medium at 37° C.

The chewing time was 10 minutes.

The buffer from the chewing process was collected and filtered through weighed filter paper (pore size 5-10 micrometer) and dried in an oven at 50° C. until dry.

CG99 was a extruded chewing gum pellet comprising tobacco powder corresponding to a nicotine content of 2% by weight of the pellet.

CG100 was a 2 layer compressed chewing gum tablet with tobacco powder in one layer corresponding to a nicotine content of 2% by weight of the tablet.

CG102 was an extruded chewing gum pellet comprising no tobacco powder and thus represents a blind.

TABLE 9
Release of tobacco fibers from chewing gum tablets
and chewing gum pellets compared to a blind.

| | | | Dried filter | Fibers re- | Fibers retained | Release of fi- |
|---|---|---|---|---|---|---|
| | Initial amount | | paper with | tained on | on the filter cor- | bers (>10 μm) |
| | tobacco powder | Filter paper | fibers | the filter | rected for blind | from chewing |
| Product | mg | Mg | mg | mg | mg | gum % |
| CG99 | 127 | 547 | 558.4 | 11.4 | 17.8 | 35 |
| CG100 | 97.6 | 546.7 | 571.5 | 24.8 | 31.2 | 80 |
| CG102 | 0 | 537.6 | 531.2 | −6.4 | 0 | 0 |

The chewing gums CG 99 and CG 100 were made from the below gum bases GB 99 and GB 100 and the applied tobacco powder was added to the chewing gum composition.

| | GB99 | GB100 |
|---|---|---|
| Elastomer | 14 | 20 |
| Resins | 40 | 37 |
| Filler | 21 | 19 |
| Plasticizers | 24.9 | 23.95 |
| Antioxidant | 0.1 | 0.05 |

The chewing gum compositions were:

| | CG99 | CG100 |
|---|---|---|
| GB99 | 40 | |
| GB100 | | 42 |
| Tobacco particles | 12.7 | 6.1 |
| Bulk Sweetener | 38 | 46 |
| Flavour | 2.5 | 2.35 |
| Intense sweeteners | 1.8 | 1.25 |
| Buffer and softener | 5.0 | 2.3 |

Table 9 shows that about 35% of tobacco fibers are released in an extruded chewing gum pellet (CG 99),

It should be noted that the retention of tobacco particles refer to the fibre content as initial content of e.g. humidity or other compounds, in particular hydrophilic compounds in the tobacco powder will at least to some extend be released during chewing. In the present context, measurements have shown that the applied tobacco particles contains about 60% hydrophilic components and about 40% fibres.

It should also be noted that CG100 shows a relatively high release of tobacco fibers. In this context, it should be noted that compressed chewing gum release nicotine even faster than CG99 which is a conventional mixed chewing gum. Hence, the relative release of fibres is also less than the release of nicotine in CG100.

It has been shown that fibres of tobacco particles showed retention in the gum base and only moderate transferring of the tobacco fibre content of the tobacco particles into the saliva occurs when using a mixed chewing gum even in spite of the fact that the nicotine releases faster.

Other visual tests performed on extruded or batch mixed chewing gums indicated that fibre content of the tobacco powder is retained to a large degree in spite of the fact that the chewing gum tested all showed increased release of nicotine compared to conventional nicotine chewing gum, where the nicotine is contained in e.g. NPR. In other words, there were clear indications that the chewing gums according to the provisions of the invention were able to retain substantial amounts of the tobacco fibres and release the nicotine contained in the tobacco powder.

### Example 10

### Preparation of Gum Base with Tobacco Particles by z-Blade Mixing

The composition of a further gum base is presented in Table 10.

TABLE 10
Gum base composition. Amounts are given in wt-% of the gum base.

| | GB std. |
|---|---|
| Elastomer | 16.0 |
| Resins | 44.5 |
| Filler | 5.0 |
| Tobacco particles | 10.0 |
| Plasticizers | 24.4 |
| Antioxidant | 0.1 |

GB = Gum Base.

As compared to the gum base of example 1, tobacco particles are included in the gum base. This gum base is further made into a chewing gum as described in example 2, only without the tobacco particles. However, obviously a combination of tobacco particles inside and outside a gum base may be used as well within the scope of the present invention.

### Example 11

### Preparation of Gum Base with Tobacco Particles by Continuous Extrusion

The composition of gum bases are presented in Table 11.

TABLE 11
Gum base composition. Amounts are given in wt-% of the gum base.

| | GB103 | GB104 | GB105 | GB106 |
|---|---|---|---|---|
| Elastomer | 15 | 15 | 15 | 15 |
| Gum resins | 20 | 20 | 20 | 20 |
| Synthetic resins | 15 | 15 | 15 | 15 |
| Filler | 25 | 15 | 20 | 5 |
| Tobacco fibres | 0 | 10 | 5 | 20 |
| Plasticizers | 15 | 15 | 15 | 15 |
| Emulsifier | 10 | 10 | 10 | 10 |
| Antioxidant | 0.1 | 0.1 | 0.1 | 0.1 |

GB = Gum Base.

A gum base composition in the form of pellets was fed directly to an extruder in a first opening. Tobacco fibres of below 10 microns were introduced in the first opening together with the gum base pellets.

The gum base pellets were fed individually to the extruder (Leistrits ZSE/BL 360 kw 104, available from GALA GmbH, Germany) The resulting composition was extruded to a granulator comprising a die plate and a water-filled chamber (granulator AS PAC 6, GALA GmbH, Germany) connected to a water system comprising a water supply for the granulator and centrifugal dryer (TWS 20, available from GALA GmbH, Germany).

The individual gum base compositions (GB103-GB106) of Table 11 were fed to the extruder with a feed rate of 250 kg/h and an extruder screw speed of 200 rpm. The gum base compositions were made in separate productions. The temperature in the composition at the feed end of the extruder was 100 and the temperature of the composition at the outlet of the extruder was 109° C. The composition was delivered by the extruder device to the inlet side of a die plate at a pressure of 36 bar. The composition was extruded through the die plate having a temperature of 200° C. and 1100 holes of a diameter of 0.3 mm. In the granulator chamber the extruded composition was cut to granules by a cutter with 13 blades mounted in star shape on a central axle rotating with a cutter speed of 2800 rpm. The granules were cooled and transported to the centrifugal dryer in water with a temperature of 17° C. and a flow rate of 22 m3/h. The average cooling and transport time in water was approx. 90 seconds. The individual granules had an average weight of 0.002 g.

In an alternative embodiment, the individual gum base compositions (GB103-GB106) of Table 11 were fed to the extruder with a feed rate of 250 kg/h and delivered to the inlet side of the die plate at a temperature of 110° C. and a pressure of 52 bar. The gum base compositions were made in separate productions. The composition was extruded through a die plate having a temperature of 119° C. and 24 holes of a diameter of 0.3 mm. In the granulator chamber the extruded composition was cut to granules by a cutter with 13 blades on a central axle rotating with a cutter speed of 2800 rpm. The granules were cooled and transported to the centrifugal dryer in water with a temperature of 18° C. and a flow rate of 23 m3/h. The average cooling and transport time in water was approx. 90 seconds. g.

In a further alternative embodiment the individual gum base composition (GB103-GB106) of Table 11 was fed to the extruder with a feed rate of 200 kg/h and delivered to the inlet side of the die plate at a temperature of 111° C. and a pressure of 72 bar. The gum base compositions were made in separate productions. The composition was extruded through a die plate having a temperature of 200° C. and 700 holes of a diameter of 0.2 mm. In the granulator chamber the extruded composition was cut to granules by a cutter with 13 blades on a central axle rotating with a cutter speed of 2800 rpm. The granules were cooled and transported to the centrifugal dryer in water with a temperature of 19° C. and a flow rate of 23 m3/h. The average cooling and transport time in water was approx. 90 seconds.

In a further alternative embodiment the gum base composition (GB103-GB106) of Table 11 was fed to the extruder with a feed rate of 250 kg/h and delivered to the inlet side of the die plate at a temperature of 109° C. and a pressure of 71 bar. The gum base compositions were made in separate productions. The composition was extruded through a die plate having a temperature of 177° C. and 1500 holes of a diameter of 0.36 mm. In the granulator chamber the extruded composition was cut to granules by a cutter with 13 blades on a central axle rotating with a cutter speed of 2700 rpm. The granules were cooled and transported to the centrifugal dryer in water with a temperature of 19° C. and a flow rate of 22 m3/h. The average cooling and transport time in water was approx. 90 seconds.

### Example 12

### Preparation of Compressed Chewing Gum

The composition of compressed chewing gum is presented in Table 12.

TABLE 12
Compressed chewing gum composition. Amounts are given in wt-%
of the chewing gum formulation.

| | CG103 | CG104 | CG105 | CG106 |
|---|---|---|---|---|
| GB103 | 32 | | | |
| GB104 | | 32 | | |
| GB105 | | | 32 | |
| GB106 | | | | 32 |
| Sorbitol | 21.5 | 21.5 | 21.5 | 21.5 |
| Acesulfame K | 0.1 | 0.1 | 0.1 | 0.1 |
| Aspartame | 0.2 | 0.2 | 0.2 | 0.2 |
| Buffer | 1.5 | 1.5 | 1.5 | 1.5 |
| Flavor | 1.5 | 1.5 | 1.5 | 1.5 |
| Xylitol | 40 | 43.2 | 41.6 | 43.2 |
| Tobacco fibres | 3.2 | 0 | 1.6 | 0 |

The gum base granules obtained in Example 11 (GB103-GB106) were individually mixed in a standard mixer with chewing gum ingredients in the form of powder as outlined in Table 12.

Before pressing, the gum base granules with the chewing gum ingredients in the form of powder, the gum base granules passed a standard horizontal vibration sieve for removing any particles larger than 1.3 mm. The mixture was subsequently conveying to a standard tablet pressing machine comprising dosing apparatus (P 3200 C, available from Fette GmbH, Germany) and pressed into compressed chewing gum tablets of 0.5 g. The pressure was 33.0-33.6 kN. A further bulk portion of 0.5 g in the form of powder was conveyed to the tablet pressing machine and further pressed into a two-layered compressed tablet having a total weight of 1.0 g. The pressure was 33.0-33.6 kN.

### Example 13

### Release of Nicotine from Compressed Chewing Gum

The nicotine release of the compressed chewing gum from Example 12 is presented in Table 13.

TABLE 13
Compressed chewing gum composition. Release in % of actual content.
Nicotine content of the tobacco fibres is 1.22% by weight of the
tobacco fibres.

| min | CG103 | CG104 |
|---|---|---|
| 1 | 55.51 | 20.30 |
| 2 | 57.63 | 35.39 |
| 5 | 68.58 | 49.55 |
| 10 | 77.68 | 59.79 |
| 20 | 94.85 | 81.33 |
| 30 | 103.55 | 92.77 |

It appears that the release of nicotine from the compressed chewing gum where the tobacco fibres are included in the at least gum base portion before mixture with the soluble bulk portion (CG104) is considerably extended when compared to CG103. In particular, the release of nicotine is extended in the first few minutes of chewing. After for example one minute, the release of GC104 is extended up to about 3 times when compared to GC103. It was noted that the burning (throat irritation) in the initial minutes of chewing was immense in CG103 and may be greatly diminished in CG104.

Further it was found that CG104 had a better stability than CG103. Furthermore, the taste and texture of CG104 was improved when compared to CG103 and the appearance was more convenient from a visual perspective.

1. A tobacco chewing gum composition comprising at least one water insoluble gum base portion and a water soluble bulk portion, wherein the at least one gum base portion and the bulk portion is combined, and wherein nicotine-containing tobacco fibres are included in the at least one gum base portion before combining the at least one gum base portion with the bulk portion.

2. The gum composition according to claim 1, wherein the tobacco fibres are included in the at least one gum base portion during an extrusion process in a continuous extrusion mixer.

3. The chewing gum composition according to claim 1, wherein the tobacco fibres are included in the at least one gum base portion during an extrusion process in a continuous extrusion mixer and allowed to mix for at least 20 seconds.

4. The chewing gum composition according to claim 1, wherein the tobacco fibres are included in the at least one gum base portion during an extrusion process in a continuous extrusion mixer, whereby the at least one gum base portion and the tobacco fibres are introduced in a first section of the continuous extrusion mixer.

5. The chewing gum composition according to claim 1, wherein the tobacco fibres are included in the at least one gum base portion during an extrusion process in a continuous extrusion mixer, whereby the at least one gum base portion is introduced in a first section of the continuous extrusion mixer and the tobacco fibres are introduced in a second section downstream of the first section of the continuous extrusion mixer.

6. The chewing gum composition according to claim 1, wherein the tobacco fibres are included in the at least one gum base portion in an amount from 5 to 40% by weight of the at least one gum base portion.

7. The chewing gum composition according to claim 1, wherein a content of nicotine in the tobacco fibres is from 0.5 to 8% by weight of the particles of tobacco fibres.

8. The chewing gum composition according to claim 1, wherein 90% of the tobacco fibres are below 300 microns.

9. The chewing gum composition according to claim 1, wherein the tobacco fibres are present in a range of 1 to 10% by weight of the chewing gum composition.

10. The chewing gum composition according to claim 1, wherein the at least one gum base portion comprises at least two of a gum resin, a synthetic resin, an elastomer and a plasticizer.

11. The chewing gum composition according to claim 2, wherein the continuous extrusion mixer is equipped with a die plate and a cutter in order to produce a plurality of extruded granules by way of pressure in the continuous extrusion mixer.

12. The chewing gum composition according to claim 1, wherein the extruded granules are conveyed into a water-filled chamber or an air-filled chamber.

13. The chewing gum composition according to claim 1, wherein the at least one gum base portion is comprised in granules.

14. The chewing gum composition according to claim 1, wherein the at least one gum base portion is in the form of granules.

15. The chewing gum composition according to claim 14, wherein the granules have an average size of 500-1300 microns.

16. The chewing gum composition according to claim 1, wherein the at least one gum base portion and the bulk portion is combined and compressed into a compressed chewing gum tablet.

17. The chewing gum composition according to claim 1, wherein the at least one gum base portion, in the form of granules, and the bulk portion, in the form of powder, is combined and compressed in a tableting machine into a compressed chewing gum tablet.

18. The chewing gum composition according to claim 1, wherein the granules comprising the at least one gum base portion and the bulk portion, in the form of powder, are combined and compressed in a tableting machine into a compressed chewing gum tablet.

19. The chewing gum composition according to claim 1, wherein the at least one gum base portion, in the form of granules, and the bulk portion, in the form of powder, are combined and compressed in a tableting machine, and at least one further bulk portion, in the form of powder, is added in the tableting machine and compressed to form a multi-layered compressed chewing gum tablet.

20. The chewing gum composition according to claim 1, wherein the granules comprising the at least one gum base portion and the bulk portion, in the form of powder, are combined and compressed in a tableting machine, and at least one further bulk portion, in the form of powder, is added in the tableting machine and compressed to form a multi-layered compressed chewing gum tablet.

21. The chewing gum composition according to claim 1, wherein the gum base content is in the range of 10 to 50% by weight of the chewing gum composition.

22. The chewing gum composition according to claim 1, wherein tobacco fibres are further included in the water soluble bulk portion.

23. The chewing gum composition according to claim 1, wherein a further gum base portion without tobacco fibres is present.

24. Gum base granules according to claim 1 comprising at least one water insoluble gum base portion, wherein tobacco fibres are included in the at least one gum base portion.

25. A method of producing a chewing gum composition according to claim 1, wherein at least one gum base portion and a bulk portion are combined, and wherein nicotine-containing tobacco fibres are included in the at least one gum base portion before combining the at least one gum base portion with the bulk portion.
